(19) United States
(12) Patent Application Publication
(10) Pub. No.: US 2026/0360265 A1
(43) Pub. Date: Nov. 12, 2026

(54) GROUND OBSTACLE AWARENESS AND WARNING BASED FLIGHT PLAN UPDATING

(71) Applicant: Wisk Aero LLC, Mountain View, CA (US)

(72) Inventors: Michael Miles, Erie, CO (US); Shilpa Nanjundaiah, Mountain View, CA (US); Sumant Sharma, San Francisco, CA (US)

(73) Assignee: Wisk Aero LLC, Mountain View, CA (US)

(21) Appl. No.: 19/674,733

(22) Filed: May 12, 2026

Related U.S. Application Data
(60) Provisional application No. 63/804,235, filed on May 12, 2025.

(51) Int. Cl. G08G 5/80; B64D 45/04; G05D 1/622; G05D 109/22; G08G 5/21; G08G 5/34; G08G 5/74

(52) U.S. Cl. CPC G08G 5/80; B64D 45/04; G05D 1/622; G08G 5/21; G08G 5/34; G08G 5/74; G05D 2109/22

(57) ABSTRACT

Systems, methods, and non-transitory, processor-readable media may provide for updating a flight plan. While along a first flight path based on a first flight plan, aircraft state information may be transmitted to a terrain avoidance and warning system (TAWS). TAWS information may be received, the TAWS information indicating a ground obstacle along an upcoming portion of the first flight path. The first flight plan may be updated to a second flight plan to avoid the ground obstacle based on the TAWS information. An aircraft may be caused to update from the first flight path to a second flight path based on updating the first flight plan to the second flight plan.

### CROSS-REFERENCE TO RELATED APPLICATION

This application claims benefit under 35 USC § 119(e) to U.S. Provisional Patent Application No. 63/804,235 filed May 12, 2025, the disclosure of which is incorporated by reference herein in its entirety for all purposes.

### TECHNICAL FIELD

This disclosure generally relates to aircraft technology and more particularly to ground obstacle awareness and warning based flight plan updating.

### BACKGROUND

In the aviation industry, a terrain awareness and warning system (TAWS) is used to detect an upcoming obstacle during flight. In a conventional piloted aircraft, a pilot may manually guide an airplane away from a ground obstacle in response to receiving a warning from the TAWS. In a pilotless aircraft, avoiding a ground obstacle may require updating a flight plan guiding the aircraft. The pilotless aircraft may need additional lead time to react to a TAWS warning during flight.

Thus, there is a need for solutions that address these challenges and problems. This and other needs are addressed by the present disclosure.

### BRIEF SUMMARY

Certain embodiments according to the present disclosure relate generally to generally relates to aircraft monitoring and control and more particularly to ground obstacle awareness and warning based flight plan updating.

Various embodiments may provide a computing system for determining future potential TAWS alerts based on an intended flight plan for an aircraft (e.g., an autonomous aircraft). The computing system may determine intended aircraft state information including for example, velocity information, position information, altitude information, heading information, or other state information, based on an intended future aircraft trajectory. The intended aircraft state information and/or the intended flight plan may then be provided to a terrain awareness and warning system (TAWS), which may generate expected alerts based on the intended aircraft state information and the intended flight plan. The computing system may receive the expected TAWS alerts and may update the intended flight trajectory to avoid or otherwise eliminate the expected TAWS alerts. The computing system may perform one or more iterations until no expected TAWS alerts are generated for the intended flight plan.

Embodiments may involve the injection of aircraft state information representing a future intended trajectory into the TAWS to determine ahead of time whether the intended trajectory may result in a TAWS alert being issued prior to reaching that point in the actual flight. Accordingly, embodiments may allow the aircraft to take actions necessary to mitigate a TAWS alert which would otherwise force a contingency event.

In some embodiments, the computer system may revise a planned (e.g., future) flight plan before the aircraft is in the air. Alternatively, or in addition, the computer system may update a flight plan during flight. An autonomous aircraft (e.g., pilotless aircraft) may include an aircraft computing system that includes multiple subsystems for controlling the aircraft. For example, the aircraft may include a sensor subsystem that continuously collects state information for the aircraft. The state information may include, for example, velocity information, position information, altitude information, heading information, or other state information. The aircraft may also include a collision avoidance subsystem that is configured to predict future aircraft states based on the current state information collected by the sensor subsystem. The collision avoidance system may provide the predicted state information to a terrain awareness and warning system (TAWS) that may determine whether the aircraft is to collide with a ground obstacle in the future if it continues using the current flight plan.

If the TAWS issues a warning that the aircraft is to collide with a ground obstacle in the future, the current flight plan may be updated while the aircraft is still in flight. Based on the configuration of the aircraft computing system, the flight plan may either be updated locally or externally via a flight supervision platform. The aircraft may implement the updated flight plan to change the aircraft's heading and/or altitude to avoid the ground obstacle.

In one aspect, a method may include one or a combination of the following. While an aircraft is along a first flight path based on a first flight plan, aircraft state information may be transmitted to a terrain avoidance and warning system (TAWS). TAWS information indicating a ground obstacle along an upcoming portion of the first flight path may be received. The first flight plan may be updated to a second flight plan to avoid the ground obstacle based on the TAWS information. An aircraft may be redirected from the first flight path to a second flight path based on updating the first flight plan to the second flight plan.

In another aspect, an aircraft computing system onboard an aircraft may include one or more processing devices and one or more computer-readable media having stored thereon instructions that, when executed, cause the aircraft computing system to perform one or a combination of the following operations. While the aircraft is along a first flight path based on a first flight plan, aircraft state information may be transmitted to a terrain avoidance and warning system (TAWS). TAWS information indicating a ground obstacle along an upcoming portion of the first flight path may be received. The first flight plan may be updated to a second flight plan to avoid the ground obstacle based on the TAWS information. An aircraft may be redirected from the first flight path to a second flight path based on updating the first flight plan to the second flight plan.

In yet another aspect, one or more non-transitory, computer-readable media may store instructions that, when executed by one or more processing devices, cause a system to perform one or a combination of the following operations. While an aircraft is along a first flight path based on a first flight plan, aircraft state information may be transmitted to a terrain avoidance and warning system (TAWS). TAWS information indicating a ground obstacle along an upcoming portion of the first flight path may be received. The first flight plan may be updated to a second flight plan to avoid the ground obstacle based on the TAWS information. An aircraft may be redirected from the first flight path to a second flight path based on updating the first flight plan to the second flight plan.

In various embodiments, prior to the transmitting the aircraft state information, a vectorization command to update a third flight plan to the first flight plan may be processed. The TAWS information may indicate the ground obstacle based on updating the third flight plan to the first flight plan. In various embodiments, the TAWS information may be transmitted to a flight supervision platform along with a request for the second flight plan. A response from the flight supervision platform may be processed. The response may include the second flight plan. In various embodiments, the second flight plan may be determined locally via a ground collision avoidance system (GCAS) based on the TAWS information.

In various embodiments, sensor information may be processed and may include one or more of position information, altitude information, velocity information, and/or attitude information. The aircraft state information may be predicted with respect to a time point based on the sensor information. The aircraft state information may include predicted aircraft state information. In various embodiments, a predicted first flight path may be determined for a threshold distance. The aircraft state information may be based on the predicted first flight path. In various embodiments, a predicted first flight path may be determined for a plurality of time points over a threshold time interval. The aircraft state information may be based on the predicted first flight path.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example aircraft flight plan from a starting location to a destination, according to one or more embodiments.

FIG. 2 illustrates an example aircraft computing system, according to one or more embodiments.

FIG. 3 illustrates an example updated flight plan, according to one or more embodiments.

FIG. 4 illustrates an example terrain and awareness warning system (TAWS) window, according to one or more embodiments.

FIG. 5 illustrates an example signaling diagram for updating a flight plan, according to one or more embodiments.

FIG. 6 illustrates an example process for updating a flight plan, according to one or more embodiments.

FIG. 7 illustrates a block diagram of an example flight supervision platform for communication with autonomous aircraft, according to one or more embodiments.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

Techniques disclosed herein relate generally to techniques for updating a flight plan prior to, and/or during flight based on a terrain and awareness warning system (TAWS) warning. More specifically, techniques disclosed describe a computing system that may determine a predicted state of a pilotless aircraft traveling along a flight path that is preloaded to the computing system (e.g., a flight control system) of the aircraft. The flight path may be based on a predetermined flight plan provided to the aircraft computing system by a flight supervision platform. As used herein the predetermined flight plan may include the instructions for following a route from a starting point to a destination. The flight plan may be provided to the aircraft computing system prior to departure. The flight path may include the actual route that the aircraft will be traveling from the starting point to the destination.

The aircraft computing system may use the current state information of the aircraft or a predetermined flight plan to predict state information for an upcoming portion of a flight plan. The aircraft computing system may predict a future state of the aircraft at various points along a flight plan based on at least the current state information. For example, the aircraft may be at a first position, and in thirty seconds, the aircraft computing system may predict that the aircraft will be in a second position. The aircraft computing system may predict state information (e.g., velocity, position, altitude, or other state information) for the second position based on at least on the current state information at the first position. The predicted state information may be provided to the TAWS, which may use the information to determine whether the aircraft is approaching a ground obstacle at a further third position. As used herein, ground obstacles may include man-made obstacles such as buildings, towers, powerlines, other structures, etc., as well as terrain, such as mountains, hills, rock formations, etc., which may present a collision risk. The TAWS may or may not be provided with information indicating that the state information is predicted state information, rather than current state information. However, from the TAWS perspective, the determination of an upcoming ground obstacle may be processed the same whether the state information is current or predicted. It should be appreciated that although the embodiments herein are described with respect to a TAWS, one of ordinary skill in the art may contemplate that the embodiments herein may be applied to various collision avoidance systems, including the TAWS, a ground proximity warning system (GPWS), or other collision avoidance system. Additionally, while certain embodiments describe the use of a static, preloaded terrain/obstacle database, it should be appreciated that the database may be dynamically updated with ground obstacle data generated by onboard or external sensors. The integration of sensed ground obstacle data may allow the collision avoidance system to account for real-time changes in the operating environment, thereby improving the reliability and safety of autonomous or piloted flight operations.

The flight plan may include computer-readable instructions for traveling from a starting point to a destination. The flight plan may include a set of waypoints that the aircraft is to travel through during the flight from a starting point to a destination. The flight plan may further include altitude and velocity parameters during different points along the flight. The flight plan may be subdivided into phases, such as a departure phase, a climb phase, and enroute phase, a descent phase, an approach phase, and a landing phase. The departure phase may include taxiing and take-off (e.g., vertical take-off). The climb phase may include an aircraft climbing to a cruising altitude. The enroute phase may include the aircraft flying at the cruising altitude. The descent phase may include the aircraft reducing its altitude. The approach phase may include preparing the aircraft to land on the surface. The landing phase may include the aircraft touching down on the surface.

In various embodiments, phases of flight may be defined in multiple ways. In some embodiments, phases of flight may be defined by aircraft behavior. For example, a descent phase may be identified by the aircraft performing a descending flight (e.g., a decrease in altitude over time). In addition or in alternative, phases of flight may be defined according to regulatory standards, such as by the aircraft's proximity to an airport or aerodrome. For instance, the “Terminal” environment described in DO-367 and other standards may designate a specific flight phase based on whether the aircraft is operating within a prescribed distance from an airport or within certain altitude bands as set forth by regulation. Accordingly, a given phase of flight may be determined by one or more of: observed aircraft behavior, regulatory definitions, or a combination thereof. The aircraft computing system may be configured to select or prioritize phase definitions depending on the operational context and applicable regulations. This flexibility permits the techniques described herein to be applied in compliance with both operational and regulatory requirements, and to allow for dynamic phase determination as needed during flight.

According to various embodiments, a sequential analysis of the flight plan may be performed. The computing system of the aircraft may slice the flight plan into a smaller segments and provide each state to the collision avoidance system (e.g., TAWS) for analysis. The collision avoidance system may analyze one segment at a time. Each segment may be kept as is when there are no warnings or may be updated in response to a warning.

The sequential analysis may similarly be applied to any candidate trajectory, including those generated for special operational needs. For example, the aircraft computing system may generate and analyze rejoin trajectories that reconnect to the original flight path after a deviation, or contingency trajectories that are designed for emergency diversion, holding, or avoidance maneuvers. Each of these trajectories may be evaluated for terrain and other ground obstacle conflicts using the same predictive techniques, ensuring comprehensive situational awareness regardless of the path chosen or required by operational circumstances. The aircraft computing system may generate and evaluate alternative trajectories to avoid detected obstacles. Such alternative trajectories may include, but are not limited to, holding patterns, emergency landing approaches, return-to-base routes, or deviation paths around restricted airspace. The selection among alternative trajectories may be based on aircraft performance, regulatory requirements, and situational factors such as weather or traffic.

In some instances, an aircraft may receive instructions to change flight directions from a command station, such as a flight supervision platform. For example, the aircraft may receive a vectorization command that may include directions for the aircraft to fly in a specified heading or altitude. In response to receiving the instructions from the flight supervision platform, the computing system (e.g., the flight control system) of the aircraft may perform a series of actions (e.g., adjusting speed, altitude, and/or attitude, modifying power provided to the propellers, among other actions) to implement the instruction. This may occur, for example, for sequencing and spacing (e.g., establishing safe distance from another aircraft), unexpected weather, or navigation assistance (e.g., assistance with reaching a next waypoint) or other reason. For each of these situations, the potential for collision with a ground obstacle may not have been considered prior to issuing the instructions. Therefore, the aircraft computing system may provide current and predicted state information to the TAWS. Based on the state information, the TAWS may indicate whether the aircraft is likely to collide with a ground obstacle if it continues with the same flight plan. According to various embodiments, the TAWS response or alert may be provided to the aircraft supervision platform. In some embodiments, the flight supervisor platform may provide an updated flight plan to the aircraft (e.g., to the flight control system of the aircraft). In other embodiments, the aircraft may use the onboard aircraft computing system to generate an updated flight plan. In either embodiment, the aircraft computing system may process the updated flight plan to direct the aircraft away from the ground obstacle.

The embodiments herein provide several technical advantages over conventional aircraft computing systems. Existing flight computing systems may rely on static pre-programmed flight plans. Even if a TAWS warning is triggered, the warning is typically in close proximity to the ground obstacle, and a mitigating flight maneuver may be determined on the spot by the aircraft's pilot. This may be time-consuming and require dedicated communication resources between the pilot and a flight supervision platform. Additionally, by supporting multiple alert severities and corresponding response protocols, the disclose system may enable earlier detection and mitigation of potential hazards. For example, less severe caution alerts may be used to provide situational awareness to human supervisors, allowing them the option to intervene early, whereas more severe warning alerts may trigger mandatory autonomous avoidance actions by the aircraft. This graded response framework may improve operational safety and flexibility, reducing the risk associated with delayed or missed interventions.

The embodiments described herein permit the use of the TAWS warning to predict an upcoming obstacle and to dynamically update the flight plan to avoid the ground obstacle. Conventional systems may also rely heavily on multiple communications from ground-based support at an external computing system (e.g., air-traffic controller system) to avoid a ground obstacle based on a TAWS warning. Therefore, a breakdown in the communication system may cause the pilot to receive incomplete information. The herein described techniques permit an autonomous aircraft to dynamically update its flight plan (or receive an updated flight plan from the remote supervision platform) based on a predicted collision with a ground obstacle. This reduces the aircraft's reliance on external computing systems, which reduce the probability of failure due to an issue at the external computing system or due to an issue of a communication system between the aircraft computing system and the external computing system. Embodiments further allow the TAWS alerts to be generated for future flight segments, giving enough lead time to an autonomous aircraft to react to the alert and avoid the predicted future hazard.

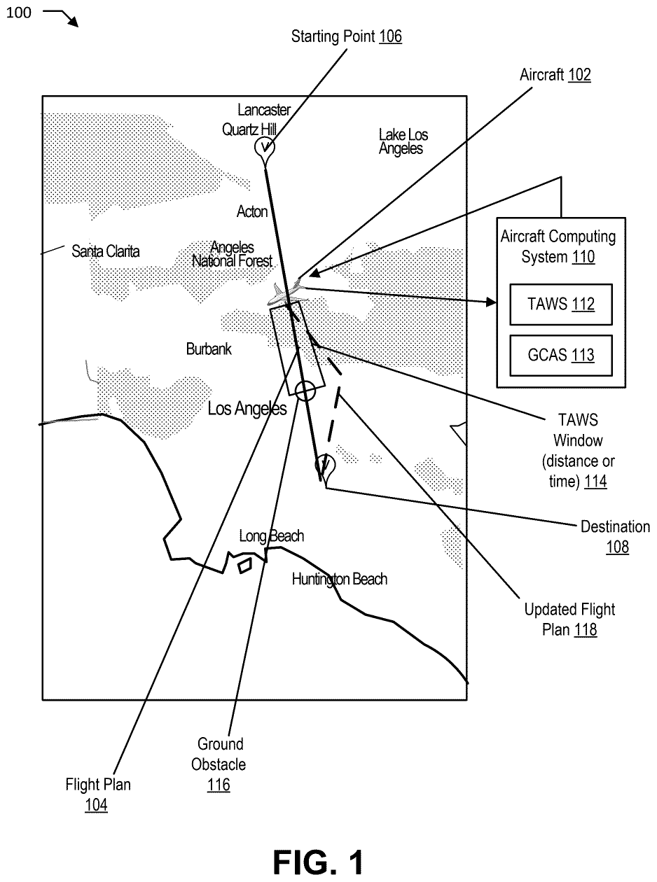

FIG. 1 is an illustration 100 of example aircraft flight plan from a starting location to a destination, according to one or more embodiments. As illustrated, an aircraft 102 may be programmed with a flight plan 104 for a flight between a starting point 106 and a destination 108. For illustration purposes, the flight plan is illustrated as a bolded line. This particular aircraft 102 may be an autonomous aircraft that has been programmed to travel from a vertiport in Lancaster Quartz Hill to a vertiport in Anaheim.

The aircraft 102 may include an aircraft computing system 110, which may include various subsystems for controlling the aircraft 102. For example, the aircraft computing system 110 may include a flight plan management system for navigating, performing calculations, and integrating with an autonomous pilot (e.g., a flight control system). The aircraft computing system 110 may further include an avionics system for communication, navigation, and sensors. The aircraft computing system 110 may further include a collision avoidance system for preventing collisions with obstacles. The collision avoidance system may include or be connected to a TAWS 112. The TAWS 112 may be a computer-implemented safety system for avoiding obstacles during flight. The TAWS 112 may analyze aircraft state information in combination with a terrain and ground obstacle database to determine any obstacles with respect to an aircraft's position.

In some embodiments, the aircraft computing system 110 may further include a ground collision avoidance system (GCAS) 113, which may operate in conjunction with or as a component of the collision avoidance system. The GCAS 113 may be configured to receive state information from onboard sensors, analyze predicted flight paths, and evaluate potential ground collision risks in real time. The GCAS 113 may process alerts from the TAWS 112 and may autonomously generate avoidance commands or updated flight plan parameters to mitigate imminent terrain or obstacle threats.

The terrain and ground obstacle database may include preloaded digital maps of terrain, ground obstacles and elevations. In some embodiments, the terrain and ground obstacle database may be dynamically updated based on data observed by onboard sensor systems during flight or on the ground. For example, a sensor system of the aircraft 102 may detect previously unmapped terrain or other ground obstacles, such as newly constructed buildings, towers, or natural formations that are not yet reflected in the preloaded database. The aircraft computing system 110 may process the sensor data to characterize the obstacle's position, dimensions, and other relevant parameters, and may update the terrain/obstacle database accordingly. The updated database may be used by the TAWS 112 to enhance the accuracy of ground obstacle awareness and warning functionalities. This dynamic updating may allow the aircraft 102 to maintain an up-to-date ground obstacle database, thereby improving the effectiveness of ground obstacle collision avoidance for both current and future flights. Additionally, the aircraft computing system 110 and/or TAWS 112 may include learning or adaptive algorithms that refine the detection and avoidance logic over time. For example, the system may incorporate machine learning techniques that analyze historical flight data to improve the accuracy of future obstacle predictions and avoidance maneuvers. In some cases, the dynamically updated ground obstacle data may be transmitted to external systems, such as a flight supervision platform or a centralized ground obstacle database, to benefit additional aircraft or flight operations. In addition or in alternative to terrain and ground obstacle database being updated with data from onboard sensors, the aircraft computing system 110 may receive real-time updates from external data sources, such as centralized airspace management systems, third-party obstacle databases, or other aircraft. Such external updates may include temporary flight restrictions or recent obstacle reports, thereby enhancing situational awareness and flight safety.

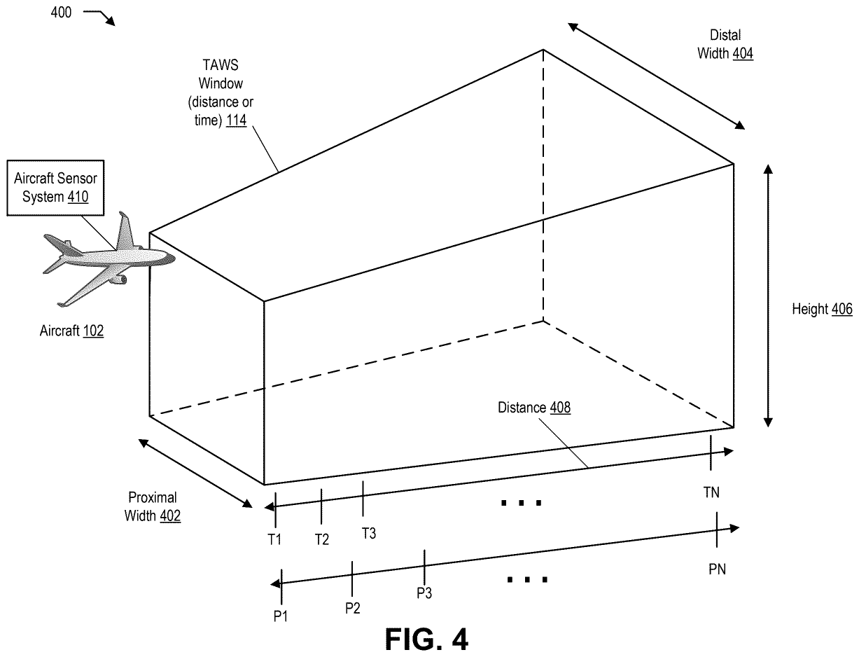

The TAWS 112 may predict a collision with a ground obstacle over a TAWS window 114. The TAWS window 114 may be based on distance or time. A distance-based TAWS window may include a window having predetermined distance ahead of the aircraft 102. For example, the distance-based TAWS window may be X meters (e.g., such as a threshold distance of 100 meters, 250 meters, 500 meters or some other distance) ahead of the aircraft. A time-based TAWS window may include a window having predetermined distance ahead of the aircraft 102 based on an expected distance over a threshold time interval. For example, the distance-based TAWS window may be Y seconds (e.g., the next Y seconds, such as 60 seconds, 120 seconds, or some other time interval) ahead of the aircraft. The TAWS window is described with more particularity with respect to FIG. 4.

The TAWS window 114 may further be associated with different types or severities of alerts, such as caution and warning alerts, each defined by different lookahead intervals. For example, a caution alert may be generated if a potential conflict is detected within a longer lookahead window, while a warning alert may correspond to conflicts within a shorter, more immediate lookahead window. The aircraft computing system 110 may utilize these escalating alert levels to support graded aircraft or supervisor responses, as further described herein.

In addition to checking terrain along simple vectors extrapolated from the current velocity and heading, the aircraft computing system 110 may be configured to perform terrain and other ground obstacle checks along any trajectory. For example, after a vectorization command, the aircraft computing system 110 may evaluate “rejoin” trajectories that return the aircraft 102 to its original or updated flight path, as well as contingency trajectories that may be invoked in response to abnormal or emergency conditions. Such flexibility allows the aircraft computing system 110 to assess potential terrain and other ground obstacle conflicts not just along the current or intended path, but also along alternative or auxiliary paths that the aircraft 102 may traverse due to operational or contingency decisions. This capability may be used both for pre-planned rejoin procedures and for dynamic updates in response to real-time events, further enhancing the safety and robustness of autonomous or semi-autonomous aircraft operations.

As illustrated, the TAWS 112 may determine that the aircraft 102 may collide with a ground obstacle 116 within the TAWS window 114. For example, the TAWS 112 may receive predicted state information (e.g., position, velocity, heading, altitude, or other state information) and/or a current position (e.g., a position in three-dimensional space) of the aircraft 102, and the predicted positions of the aircraft 102 within the TAWS window 114. In some instances, the predicted state information may be generated by the aircraft computing system 110 based on extrapolating predicted data points form a current position and current state information. For example, the TAWS 112 may determine the predicted positions of the aircraft 102 over a pre-determined distance at a current heading of the aircraft 102 and based on the velocity. In another example, the TAWS 112 may determine the predicted positions of the aircraft 102 over a pre-determined time interval at a current heading of the aircraft 102 and based on the velocity.

Additionally, in some embodiments, the predicted state information may be determined directly from an intended flight trajectory, such as the trajectory specified by the current flight plan or a modified trajectory provided by a flight supervision platform. For instance, the aircraft computing system 110 may access the intended flight plan 104, which may specify future positions, altitudes, headings, and velocities at various waypoints or segments of the flight, and may provide these intended trajectory data points as predicted state information to the TAWS 112 for analysis. This may permit the TAWS 112 to evaluate the flight plan as programmed, without relying solely on extrapolation from the current velocity or heading, thereby enabling more accurate prediction of potential conflicts with ground obstacles based on planned maneuvers or anticipated changes in the flight path.

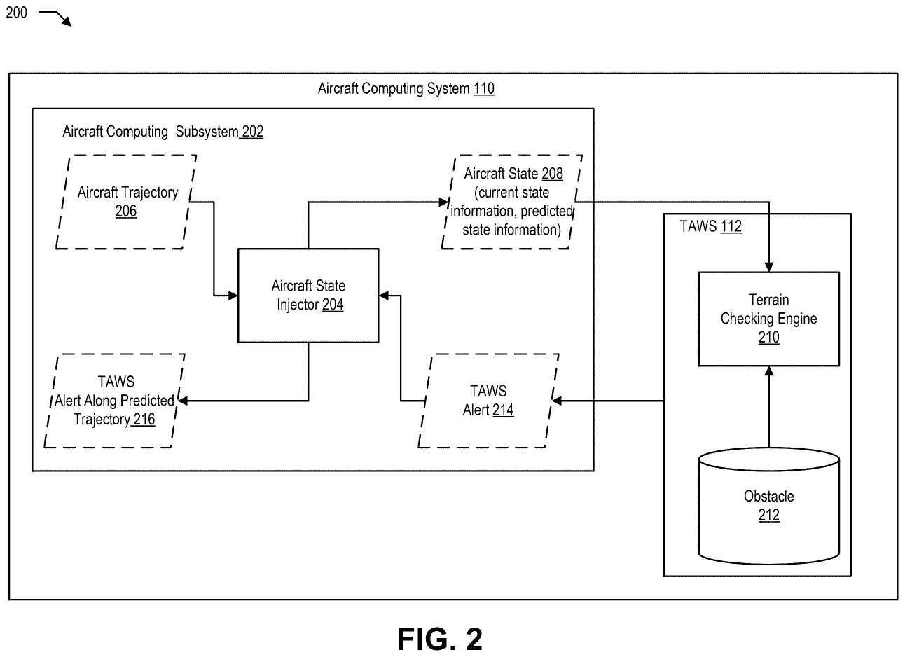

In either example, the TAWS 112 may compare the predicted positions to a terrain map. The terrain map may provide elevations of the ground and structures with which the aircraft 102 may collide. In the event that the TAWS 112 determines the aircraft 102 is to collide with a ground obstacle (e.g., ground obstacle 116), the TAWS 112 may issue a warning signal to the aircraft computing system 110. The GCAS 113 may receive the warning signal and may autonomously or cooperatively, with the TAWS 112, assess possible avoidance maneuvers or initiate an update to the flight plan. The GCAS 113 may prioritize maneuvers based on proximity, severity, or mission requirements, and may command the flight control system to execute the selected avoidance trajectory. The GCAS 113 may also communicate with the flight supervision platform, if needed, to coordinate or authorize the flight path change. The TAWS 112 is described with more particularity with respect to FIG. 2.

It should be appreciated that although a single TAWS window 114 is illustrated, the aircraft computing system 110 may utilize the TAWS 112 to continuously determine whether the aircraft 102 is to collide with a ground obstacle 116 from the starting point 106 to the destination 108. In the event that the TAWS 112 issues a warning during flight, the TAWS 112 may either communicate the warning to the aircraft computing system 110 or to a flight supervision platform. In this instance, the flight supervision platform may generate the updated flight plan 118 for the remainder of the flight path during flight and return the updated flight plan 118 to the aircraft computing system 110. The updated flight plan 118 may include one or more updated flight plan parameters (e.g., velocity, position, heading, waypoint, altitude, yaw, pitch, roll, or other flight plan parameter). Upon receiving the updated flight plan, the aircraft computing system 110 may automatically reconfigure the flight control system to execute the new set of flight plan parameters. This may include, for example, transmitting control signals to the aircraft's autopilot, navigation, and propulsion subsystems to adjust heading, altitude, velocity, and waypoint tracking as specified by the second flight plan. The control system may perform these maneuvers autonomously. The transition from the first flight path to the second flight path may be smooth or may involve predefined or dynamically computed maneuvering sequences to safely achieve the new trajectory.

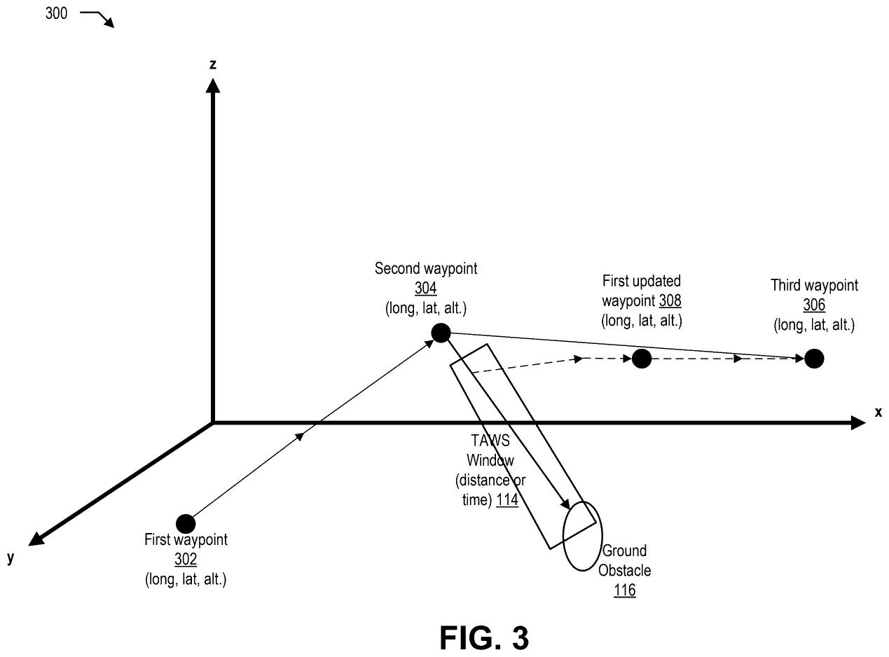

In another embodiment, the aircraft computing system 110 may generate the updated flight plan 118 during the flight. Again, the updated flight plan 118 may include one or more updated flight plan parameters (e.g., velocity, position, heading, waypoint, altitude, yaw, pitch, roll, or other flight plan parameter). The updated flight plan is described with more particularity with respect to FIG. 3.

In the illustrated example, the updated flight plan 118 may cause the aircraft 102 to travel further East to avoid colliding with the ground obstacle 116. For illustration, the updated flight plan 118 is illustrated as a dashed line.

FIG. 2 is an illustration 200 of an example aircraft computing system 110, according to one or more embodiments. The aircraft computing system 110 may include multiple aircraft computing subsystems 202 for managing and executing dynamic flight plan updates based on ground obstacle avoidance data. The aircraft computing system 110 may interface with one or more of the aircraft computing subsystems 202. For example, the aircraft computing system 110 may interface with an aircraft state injector 204 that may provide state information to the TAWS 112. In some embodiments, the aircraft state injector 204 may be implemented by, or be a functional component of, the GCAS 113. Thus, in some embodiments, functions of the aircraft state injector 204, such as predicting and providing aircraft state information to the TAWS 112, may be carried out by the GCAS 113, which may integrate predictive modeling, state estimation, and avoidance logic within a single subsystem.

The aircraft state injector 204 may receive current aircraft state information (e.g., position, velocity, heading, altitude, or other state information). The aircraft state injector 204 may also predict aircraft trajectory information 206 based on a TAWS window. Based on the predicted trajectory, the aircraft state injector 204 may generate predicted aircraft state information 208, which may include predicted positions over the TAWS window, predicted velocities over the TAWS window, predicted headings over the TAWS window, predicted altitudes over the TAWS window, or other predicted state information. For example, the aircraft state injector 204 may include a prediction engine that may extrapolate predicted state information parameters from a current position and current state information. In some embodiments, the predicted trajectory may correspond to a predicted flight path. In some embodiments, the predicted flight path may be represented as a sequence of predicted aircraft state information—such as positions, velocities, headings, and altitudes—at a plurality of points along the intended trajectory. This predicted state information may be used by the TAWS to assess potential obstacles and generate alerts.

In some embodiments, the aircraft state injector 204 may determine predicted aircraft state information based on a predicted flight path, where the predicted aircraft state information may include a set of predicted state vectors or other information (positions, velocities, headings, altitudes, etc.) at multiple points along the predicted flight path—each representing the aircraft's expected state at a given point along the trajectory. The aircraft state injector 204 may determine the current aircraft position, current velocity, current altitude, and current heading. The aircraft state injector 204 may then determine a predicted flight path based on the first flight plan. Each point along the predicted flight path may be associated with respective predicted state information over a TAWS window. For example, if the TAWS window is a time-based window, the TAWS window may be divided into timepoint 1 (T1) through time point N (TN), wherein T1 is a time point at the beginning of the TAWS window and TN is a timepoint at the end of the TAWS window. As used in this example, a current time may be T0. Each time point (e.g., T1, T2, T3, . . . , TN) may be a predicted time point associated with respective predicted state information (e.g., predicted position over the TAWS window, predicted velocity over the TAWS window, predicted heading over the TAWS window, predicted altitude over the TAWS window, or other predicted state information). In some embodiments, the time points may correspond to one or more of the different phases of the flight. Therefore, in some embodiments, T1 through TN may correspond to different time points of a phase according to the flight plan. In these embodiments, each phase may be represented by a respective set of time points.

If, for example, the TAWS window is a distance-based window, the TAWS window may be divided into position 1 (P1) through position N (PN), wherein P1 is an aircraft position at the beginning of the TAWS window and PN is an aircraft position at the end of the TAWS window. The granularity of the predicted path segmentation may be dynamically adjusted based on operational context, such as flight phase, airspace congestion, or risk level. The threshold distance or time interval for prediction may be configurable and may be automatically adapted in response to changes in aircraft speed, maneuverability, or external conditions (e.g., weather, ATC directives). As used herein, the current position may be P0. Each position (e.g., P1, P2, P3, . . . ,PN) may be a predicted position and be associated with respective predicted state information. In some embodiments, the positions may correspond to one or more of the different phases of the flight. Therefore, in some embodiments, P1 through PN may correspond to different positions of a phase according to the flight plan. In these embodiments, each phase may be represented by a respective set of positions. As described above, phases of flight may be determined based on either aircraft behavior or regulatory definitions, depending on operational requirements.

In some embodiments, the aircraft state injector 204 may determine predicted aircraft state information based not only on extrapolation from current position, velocity, altitude, or heading, but also based on an intended flight trajectory specified by the flight plan. For example, the intended flight trajectory may include a sequence of planned waypoints, altitudes, headings, and velocities, and the predicted state information may be generated directly from these intended parameters. This approach may allow the TAWS 112 to receive and analyze predicted state information reflecting the aircraft's expected future states as laid out in the intended flight plan, regardless of the aircraft's current state. In certain embodiments, the predicted state information may be determined entirely from the intended flight trajectory or may be determined as a combination of the intended flight trajectory and extrapolated current state information. By leveraging the intended flight plan as a source of predicted state information, the system 110 may anticipate and assess potential terrain or other ground obstacle conflicts that could arise if the aircraft 102 follows the planned trajectory, providing additional lead time and situational awareness for flight plan updates.

The aircraft computing subsystem 202 may transmit the predicted aircraft state information 208 to the TAWS 112. The TAWS 112 may include a terrain check engine 210 and a terrain and ground obstacle database 212. The aircraft computing system 110 may transmit information to the TAWS 112 or flight supervision platform 502 in any suitable format, such as structured data packets, XML, JSON, or proprietary binary formats. In some embodiments, the format of the state information and TAWS alerts may be standardized to facilitate interoperability between different aircraft types and ground systems. The communication protocol may include encryption, error-checking, and handshaking routines to ensure data integrity and security. For each time point or position over the TAWS window, the terrain checking engine 210 may determine whether the aircraft is to collide with obstacle. As indicated above, the terrain and ground obstacle database 212 may include information as to stationary objects that may rise along with the aircraft's path. Each ground obstacle may be associated with information as to the ground obstacle descriptors, classification, height, position, width, or other obstacle information. The terrain checking engine 210 may compare the aircraft's predicted position at each time point or position with the ground obstacle information to determine whether the aircraft is to collide with the ground obstacle. As an example, at P3 or T3, the predicted state information may include a predicted altitude as x (e.g., 1000 meters above sea level) and a predicted position as longitude y and latitude z. The terrain checking engine 210 may compare the aircraft's predicted state information with obstacle information to determine whether at P3 or T3 the aircraft will collide with a ground obstacle.

If the terrain checking engine 210 determines that the aircraft is to collide with a ground obstacle, the TAWS 112 may transmit a TAWS alert 214 to the aircraft state injector 204. The TAWS 112 may analyze predicted state information to detect potential collisions with one or more ground obstacles within the TAWS window 114. In certain embodiments, when multiple ground obstacles are detected, the aircraft computing system 110 may prioritize avoidance maneuvers based on factors such as proximity, obstacle size, obstacle type, and mission-critical parameters. The aircraft computing system 110 may select a flight plan update that resolves the most imminent or severe hazard first and may continue to evaluate remaining obstacles iteratively. The aircraft state injector 204 may verify the TAWS alert, and, if verified, output a TAWS alert along the predicted trajectory 216. For example, if the terrain checking engine 210 determines that at T3 the TAWS window anchored at the (current or predicted) aircraft position coincides with a ground obstacle's position, the TAWS 112 may output the TAWS alert 214. Or, if at P3, the aircraft's position is the same as the position of a ground obstacle, the TAWS 112 may output the TAWS alert 214. As indicated above, the TAWS alerts on predicted trajectory 216 may trigger either a flight supervision platform or the aircraft computing system 110 to update a first flight plan to a second flight plan.

In various embodiments, the TAWS 112 may generate alerts of different severities, such as less severe caution alerts and more severe warning alerts. The severity of a TAWS alert may be determined based on escalating lookahead times or distances, with caution alerts typically corresponding to less-urgent potential conflicts and warning alerts indicating imminent or more critical hazards. The aircraft computing system 110 may be configured to respond differently depending on the severity of the TAWS alert. For instance, upon receipt of a caution alert, the aircraft computing system 110 may transmit information regarding the impending—but less urgent—situation to the flight supervision platform for situational awareness. If the supervisor does not intervene or provide updated instructions in response to the caution alert, and if the situation escalates, the aircraft computing system 110 may subsequently issue a more-urgent warning alert. In response to a warning alert, the aircraft 102 may autonomously update the flight plan and execute avoidance maneuvers without waiting for supervisor input. Alternatively, in some embodiments, the aircraft 102 may be configured to autonomously respond to caution alerts as well, taking action to mitigate the risk before a warning alert threshold is reached. The aircraft computing system 110 may select the appropriate response strategy based on operational context, airspace rules, or supervisor preference.

FIG. 3 is an illustration 300 of an example updated flight plan, according to one or more embodiments. As indicated above, a flight plan may be updated based on updating one or more flight plan parameters. FIG. 3 illustrates an update to the waypoints of a flight plan. As illustrated, a flight plan or a phase of a flight plan may include a set of waypoints starting at a first waypoint 302, proceeding at a second waypoint 304, then a third waypoint 306. The waypoints may represent three-dimensional points that the aircraft is to fly through to reach a destination. Each waypoint may be defined by a respective longitude, latitude, and altitude. As indicated above, in some instances, the flight plan may be the result. The intent of the flight plan may be for the aircraft's flight path to travel from the first waypoint 302 to through the second waypoint 304 and to the third waypoint 306.

At some point during the flight, the aircraft may receive a vectorization command to change the heading of the aircraft. As illustrated, the vectorization command is received on or about the second way point. It should be appreciated that the aircraft computing system 110 may receive a vectorization command at some point that does not correspond to a waypoint. The vectorization command may be received based on various reasons, such as inclement weather, unexpected air traffic or other reason. Therefore, as illustrated, the aircraft's flight path diverts from flying from the second waypoint 304 to the third waypoint 306 and from the second waypoint 304 toward the ground obstacle 308. The aircraft computing system 110 may utilize the TAWS to determine that the ground obstacle is within the TAWS window 114. The TAWS may issue an alert indicating that the aircraft may collide with the ground obstacle 308. In response, either from a flight supervision platform or locally from the aircraft computing system, the aircraft may receive an updated flight plan (illustrated as dashed lines). The updated flight plan indicates a first updated flight waypoint 310 that is in a flight path toward the third waypoint 306. The aircraft computing system 110 may use one or more subsystems to use the updated flight plan to guide the aircraft's flight path to the third waypoint 306.

In FIG. 3, the flight plan is updated to add a waypoint. It should be appreciated that the techniques described herein may be used to update a flight plan in various ways. For example, the flight plan may be updated to remove a waypoint, move a waypoint, or modify a waypoint (e.g., update an altitude). The flight plan may be updated in various other manners as well, such as updating an altitude at a point along the flight, updating a heading, updating a velocity, or other update.

FIG. 4 is an illustration 400 of an example terrain and awareness warning system (TAWS) window, according to one or more embodiments. The TAWS window 114 may be a three-dimensional representation that is defined by a proximal width 402, a distal width 404, a height 406 and a distance 408. The distance 408 may be configured based on the sensor technology and a desired distance. For example, the distance may be based on a desired distance x (e.g., x meters, such as a threshold distance of 100 meters, 250 meters, 500 meters, or some other distance). The distance may also be based on a time interval. For example, the distance may be based an expected distance that the aircraft 102 is to travel with a time interval y (e.g., the next y seconds, such as 60 seconds, 120 seconds, or some other time interval). If the distance is based on a time interval y, then the distance may be dynamically changed by the aircraft computing system 110 based on a current velocity of the aircraft. For example, if the velocity is z kilometers per hour, the distance may be m meters. If the velocity is z−a kilometers per hour, the distance may increase to m+n meters. If the velocity is z+b, the distance may decrease to m−o meters. The proximal width 402 may be less than the distal width 404 and the height 406 may be a distance from the ground surface to an altitude higher than the current altitude of the aircraft 102. It should be appreciated that the proximal width 402, the distal width 404, the height 406, and the distance 408 are linear with no curves for illustration purposes. On having ordinary skill in the art may contemplate that any one of the proximal width 402, the distal width 404, the height 406, and the distance 408 may exhibit one or more curves.

The aircraft computing system 110 may determine whether the aircraft is to collide with a ground obstacle at different points within the TAWS window 114. As illustrated, various predicted time points (e.g., T1, T2, T3, . . . , TN) and various predicted position points (e.g., P1, P2,P3, . . . , PN) are illustrated. Although not illustrated, the aircraft 102 may be at a current state at T0 and P0. For each predicted point, the TAWS 112 may determine whether the aircraft 102 is to collide with a ground obstacle. A ground obstacle (or a portion of a ground obstacle) may be present at any position within the TAWS window 114. It is illustrated that the dimensions of the TAWS window 114 exceed the dimensions of the aircraft 102. This may provide an extra measure of safety for the aircraft. It should be appreciated that the TAWS window 114 may be parameterized with respect to a flight plan, a navigation certainty, a aerodrome proximity, or other parameter.

It should be appreciated that the TAWS window 114 is continuously in front of the aircraft 102 or a velocity track during flight. In the latter instance, the TAWS window 114 may extend lateral to the aircraft's heading during flight. The aircraft computing system 110 may continuously predict state information for each of the points (e.g., time points and position points), which may be provided to the TAWS 112. If the TAWS 112 does determine that the aircraft 102 is to collide with a ground obstacle at any point during flight, the flight plan that the aircraft 102 is currently using may be updated to avoid the ground obstacle. The aircraft computing system 110 may, upon updating the flight plan, generate and transmit control commands to one or more aircraft actuators, such as flight control surfaces, propulsion systems, or onboard navigation modules, so as to effectuate the transition from the first flight path to the second flight path. In certain embodiments, confirmation data indicating successful implementation of the updated flight plan may be received from the relevant subsystems, and the aircraft computing system 110 may further monitor real-time sensor feedback to ensure the aircraft is following the intended second flight path.

As further illustrated, the aircraft 102 may include an aircraft sensor system 410, that includes radar, light detection and ranging (LiDAR), inertial reference systems (IRS) and global positioning system, image capturing devices, and other sensors. Additional sensors that may be utilized may include, for example, ultrasonic sensors, barometric altimeters, magnetometers, and infrared cameras. The aircraft computing system 110 may employ sensor fusion techniques to combine data from multiple sensor types, thereby increasing the accuracy and reliability of the predicted aircraft state information used for obstacle avoidance and flight plan updating. The sensors may be configured to continuously monitor and collect sensor information that may be used as state information. For example, the sensor may collect information that is transmitted to circuitry for processing. In certain embodiments, the aircraft sensor system 410 may further be configured to detect and characterize terrain and obstacles that are not currently represented in the terrain and ground obstacle database. The aircraft computing system 110 may analyze the sensor data to generate ground obstacle descriptors, such as position, size, and classification, and may update the onboard terrain/obstacle database with this information. The updated ground obstacle data may be made immediately available for TAWS analysis and flight plan updating. In some embodiments, the aircraft 102 may transmit the newly detected obstacle information to an external platform or a centralized ground obstacle management system for further dissemination and use. The state information collected by the sensors may be used by an aircraft subsystem to predict state information for the aircraft for positions within the TAWS window 114.

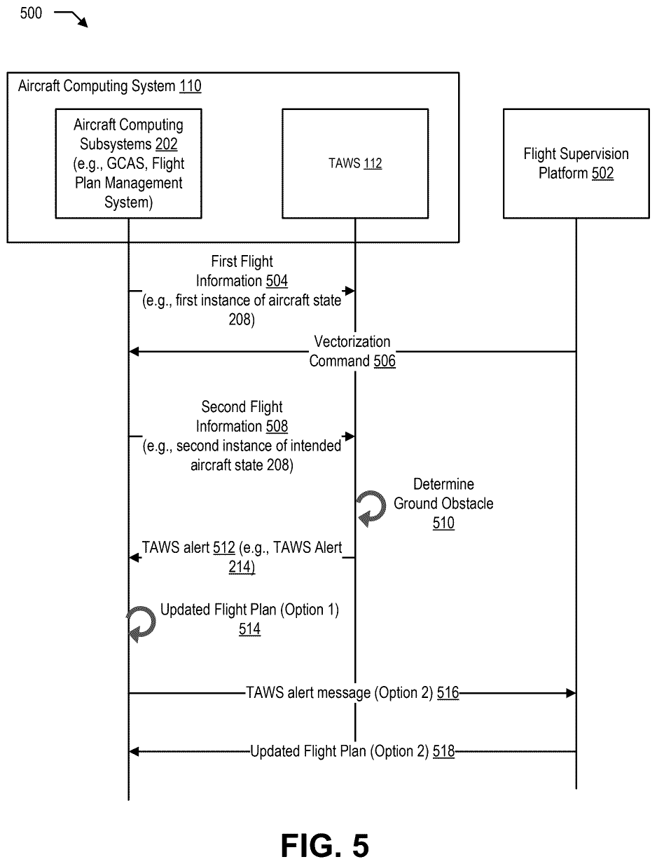

FIG. 5 is an example signaling diagram 500 for updating a flight plan, according to one or more embodiments. As illustrated, an aircraft computing system 110 may be in communication with a flight supervision platform 502. At 504, a first subsystem (e.g., a ground collision avoidance system (GCAS) from aircraft computing subsystems 202) may transmit first flight information (e.g., a first instance of aircraft state information 208) to a TAWS 112. For example, the aircraft may be at a first position (P0) at a first time point (T0) and the first flight information may be the state information at P0 and T0. As illustrated, the TAWS 112 may not determine that the aircraft is to collide with a ground obstacle.

In some embodiments, a flight supervision platform 502 may transmit a vectorization command to a second subsystem (e.g., flight plan management system) of the aircraft computing subsystems 202 at 506. For example, the vectorization command may be instructions to change the heading of the aircraft. The vectorization command may further include, or may be supplemented with, additional flight parameters such as target altitude, speed, or specific geographic coordinates, and may be processed by the aircraft computing system 110 to dynamically recalculate trajectories in real time. The aircraft computing system 110 may apply the vectorization command to a pre-existing flight plan or to a current in-flight trajectory and may assess the feasibility and safety of the resulting path prior to execution. The second subsystem may cause the heading of the aircraft to change based on the vectorization command, implementing the heading change and other vectorization command parameters by adjusting the aircraft's active flight plan or direct control inputs.

At 508, the first subsystem of the aircraft computing subsystems 202 may transmit second flight information to the TAWS 112. For example, the aircraft may currently be at P1 and/or the time may be at T1. The first subsystem may transmit second flight information (e.g., predicted state information at P2 and/or T2) to the TAWS. For example, the first subsystem may utilize an aircraft state injector (e.g., aircraft state injector 204) that uses the first flight information to predict the second flight information. Based on the second flight information, the TAWS 112 may predict that the aircraft is to collide with a ground obstacle at P2 and/or T2. For example, the TAWS 112 may use a terrain checking engine (e.g., terrain checking engine 210) along with a ground obstacle database (e.g., obstacle database 212) to compare the predicted position of the aircraft at P2 and/or T2 with obstacles indicated in the ground obstacle database. Based on the comparison, the TAWS 112 may determine that the aircraft is to collide with a ground obstacle at P2 and/or T2.

At 512, the TAWS 112 may transmit a TAWS alert (e.g., TAWS alert 214) to the first subsystem. As indicated above, the aircraft computing system 110 may either be configured to generate an updated flight plan, or an updated flight plan may be generated by, and transmitted from the flight supervision platform 502 to the aircraft computing system 110. If the aircraft computing system is configured to generate the updated flight plan, at 514, the first subsystem does so. The second subsystem may further use the updated flight plan to cause the aircraft to divert the aircraft away from the ground obstacle.

If, however, aircraft computing system 110 is to receive an updated flight plan, the first subsystem may transmit a TAWS alert message including the TAWS alert 214, and optionally a request for an updated flight plan, to the flight supervision platform 502 at 516. The TAWS information transmitted to the flight supervision platform may include not only alert signals but also detailed predicted state data, intended flight plan segments, and any relevant sensor or environmental data. The flight supervision platform 518 may process this information, generate one or more candidate second flight plans, and transmit a selected second flight plan back to the aircraft computing system, optionally accompanied by metadata indicating the basis for the update or required confirmation steps. At 518, the flight supervision platform 502 may generate and transmit the updated flight plan to the second subsystem of the aircraft. The second subsystem may further use the updated flight plan to determine and implement a set of maneuvers to divert the aircraft away from the ground obstacle.

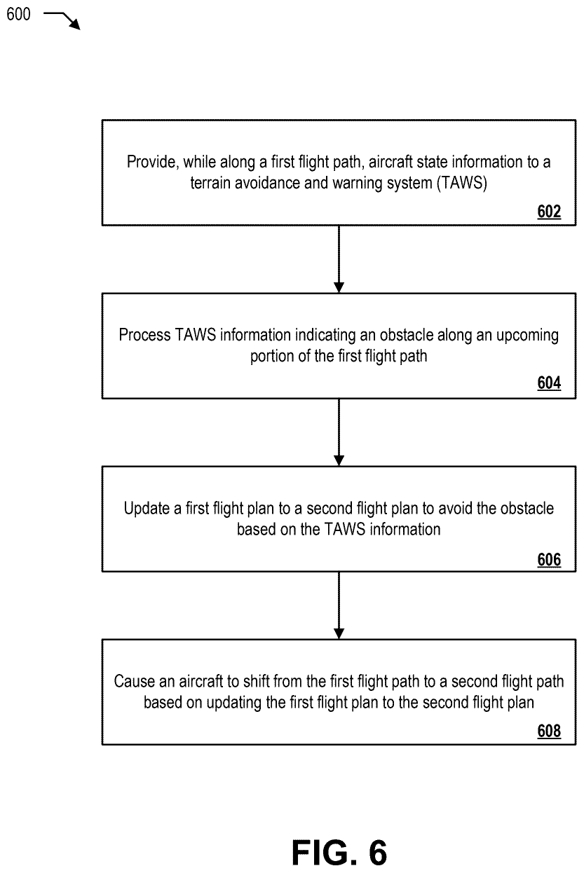

FIG. 6 is an example process 600 for updating a flight plan, according to one or more embodiments. At 602, the process may include a computing system (e.g., aircraft computing system 110 via aircraft computing subsystem 202) of an aircraft (e.g., aircraft 102) transmitting, while along a first flight path based on a first flight plan, aircraft state information (e.g., predicted aircraft state information 208) to a TAWS (e.g., TAWS 112). In some instances, the aircraft may be originally using a third flight plan. At some point, the computing system may process a vectorization command to update the third flight plan (e.g., change a heading) to the first flight plan. The TAWS information may indicate the ground obstacle based on updating the third flight plan to the first flight plan.

At 604, the process 600 may include the computing system receiving TAWS information (e.g., expected TAWS alert 214) indicating a ground obstacle (e.g., ground obstacle 116) along an upcoming portion of the first flight path.

At 606, the process 600 may include the computing system updating the first flight plan to a second flight plan to avoid the ground obstacle based on the TAWS information. The method may further include generating and evaluating one or more alternative trajectories, including but not limited to rejoin and contingency trajectories, and performing terrain and other ground obstacle checks along such trajectories to ensure that any selected path is free of conflicts prior to execution by the aircraft. As indicated above, an updated flight plan may be generated at a flight supervision platform or locally at the aircraft computing system. For example, if the updated plan is to be generated at the flight supervision platform, the aircraft computing system may transmit the TAWS information to the flight supervision platform. The computing system may then process a response from the flight supervision platform, the response comprising the second flight plan.

Alternatively, the computing system may determine, locally via a flight plan management system, the second flight plan based on the TAWS information. The local determination of the second flight plan may be performed by the GCAS employing predictive algorithms, such as trajectory optimization, obstacle avoidance heuristics, or machine learning models trained on historical flight data. In some embodiments, the GCAS may operate in parallel with or as a fallback to externally generated plans, enabling redundancy in flight safety operations.

At 608, the process 600 may include the computing system redirecting the aircraft from the first flight path to a second flight path based on updating the first flight plan to the second flight plan.

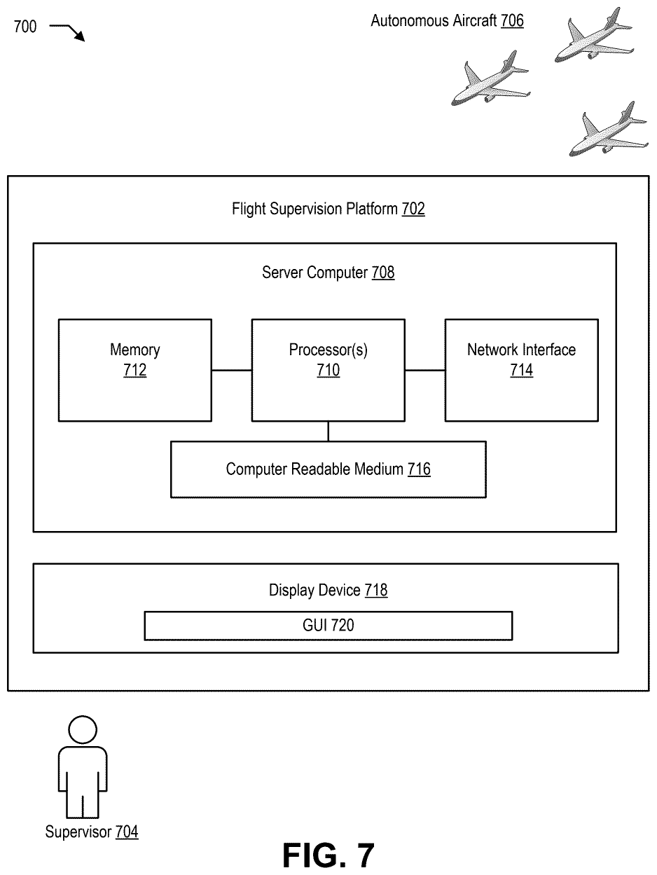

FIG. 7 illustrates a block diagram 700 of an example flight supervision platform 702 (e.g., flight supervision platform 502) that may be used by a supervisor 704 to monitor and interact with one or more autonomous aircraft 706 (e.g., aircraft 102) individually and/or collectively. For example, the flight supervision platform 702 may assist the aircraft 706 to avoid a ground obstacle. The flight supervision platform 702 may include a server computer 708 comprising one or more processors 710, a system memory 712 (which may include any combination of volatile and/or non-volatile memory such as, for example, buffer memory, RAM, DRAM, ROM, flash, or any other suitable memory device), and a network interface (e.g., an external communication interface) 714. For example, the network interface 714 may be used to interface with the aircraft computing system. In some embodiments, one or more of the modules may be disposed within one or more of the components of the system memory 712 or may be disposed externally. The server computer 708 may further include a computer-readable medium 716 for storing one or more instructions. The software and hardware modules shown in FIG. 7 are provided for illustration purposes only, and the configurations are not predicted to be limiting.

The network interface 714 may be configured or programmed to receive and generate electronic messages comprising information transmitted through the flight supervision platform 702 to or from the plurality of autonomous aircraft 706. The flight supervision platform 702 may also include at least one display device 718 for displaying a graphical user interface (GUI) 720. When an electronic message is received by the flight supervision platform 702 via the network interface 714 of the server computer 708, it may be processed and relevant information may be displayed on the display device 718 via the GUI 720. When an input is received from the supervisor 704 via the GUI 720, it may be processed and relevant information may be transmitted to the corresponding autonomous aircraft 706. For example, flight supervision platform may be used to provide the aircraft computing system with landing site information (e.g., a landing site identifier). According to various embodiments, the flight supervision platform 702 may further be configured to receive supplementary information from third parties, such as air traffic control, weather, other aircraft (e.g., aircraft that monitors the one or more autonomous aircraft 706 in the air). The supplementary information may be processed by the flight supervision platform 702 and displayed on the GUI 720.

For simplicity, various active and passive circuitry components are not shown in the figures. In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is predicted by the applicants to be the scope of the disclosure, is the literal and equivalent scope of the set of claims that issue from this application, in the specific form in which such claims issue, including any subsequent correction. The specific details of particular embodiments may be combined in any suitable manner without departing from the spirit and scope of embodiments of the disclosure.

Electronic components of the described embodiments may be specially constructed for the required purposes or may include one or more general-purpose computers selectively activated or reconfigured by a computer program stored in the computer. Such a computer program may be stored in a computer readable storage medium, such as, but is not limited to, any type of disk including floppy disks, optical disks, DVDs, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus.

Additionally, spatially relative terms, such as “front” or “back” and the like may be used to describe an element and/or feature's relationship to another element(s) and/or feature(s) as, for example, illustrated in the figures. It will be understood that the spatially relative terms are predicted to encompass different orientations of the device in use and/or operation in addition to the orientation depicted in the figures. For example, if the device in the figures is turned over, elements described as a “front” surface may then be oriented “back” from other elements or features. The device may be otherwise oriented (e.g., rotated 90 degrees or at other orientations) and the spatially relative descriptors used herein interpreted accordingly.

What is claimed:

1. A method comprising:
transmitting, by an aircraft computing system onboard of an aircraft, while the aircraft is along a first flight path based on a first flight plan, aircraft state information to a terrain avoidance and warning system (TAWS);
receiving, by the aircraft computing system, TAWS information indicating a ground obstacle along an upcoming portion of the first flight path;
updating, by the aircraft computing system, the first flight plan to a second flight plan to avoid the ground obstacle based on the TAWS information; and
redirecting, by the aircraft computing system, the aircraft from the first flight path to a second flight path based on updating the first flight plan to the second flight plan.

2. The method as recited in claim 1, further comprising:
prior to the transmitting the aircraft state information, processing a vectorization command to update a third flight plan to the first flight plan, wherein the TAWS information indicates the ground obstacle based on updating the third flight plan to the first flight plan.

3. The method as recited in claim 1, further comprising:
transmitting the TAWS information to a flight supervision platform along with a request for the second flight plan; and
processing a response from the flight supervision platform, the response comprising the second flight plan.

4. The method as recited in claim 1, further comprising:
determining, locally via a ground collision avoidance system, the second flight plan based on the TAWS information.

5. The method as recited in claim 1, further comprising:
processing sensor information comprising one or more of position information, altitude information, velocity information, or attitude information; and
predicting the aircraft state information with respect to a time point based on the sensor information, wherein the aircraft state information comprises predicted aircraft state information.

6. The method as recited in claim 1, further comprising:
determining a predicted first flight path for a threshold distance, wherein the aircraft state information is based on the predicted first flight path.

7. The method as recited in claim 1, further comprising:
determining a predicted first flight path for a plurality of time points over a threshold time interval, wherein the aircraft state information is based on the predicted first flight path.

8. An aircraft computing system onboard of an aircraft, the aircraft computing system comprising:
one or more processing devices; and
one or more computer-readable media having stored thereon instructions that, when executed, cause the aircraft computing system to perform operations comprising:
transmitting, while the aircraft is along a first flight path, aircraft state information to a terrain avoidance and warning system (TAWS);
processing TAWS information indicating a ground obstacle along an upcoming portion of the first flight path;
updating a first flight plan to a second flight plan to avoid the ground obstacle based on the TAWS information; and
redirecting the aircraft from the first flight path to a second flight path based on updating the first flight plan to the second flight plan.

9. The aircraft computing system as recited in claim 8, the operations further comprising:
prior to the transmitting the aircraft state information, processing a vectorization command to update a third flight plan to the first flight plan, wherein the TAWS information indicates the ground obstacle based on updating the third flight plan to the first flight plan.

10. The aircraft computing system as recited in claim 8, the operations further comprising:
transmitting the TAWS information to a flight supervision platform along with a request for the second flight plan; and
processing a response from the flight supervision platform, the response comprising the second flight plan.

11. The aircraft computing system as recited in claim 8, the operations further comprising:
determining, locally via a ground collision avoidance system, the second flight plan based on the TAWS information.

12. The aircraft computing system as recited in claim 8, the operations further comprising:
processing sensor information comprising one or more position information, altitude information, velocity information, or attitude information; and
predicting the aircraft state information with respect to a time point based on the sensor information, wherein the aircraft state information comprises predicted aircraft state information.

13. The aircraft computing system as recited in claim 8, the operations further comprising:
determining a predicted first flight path for a threshold distance, wherein the aircraft state information is based on the predicted first flight path.

14. The aircraft computing system as recited in claim 8, the operations further comprising:
determining a predicted first flight path for a plurality of time points over a threshold time interval, wherein the aircraft state information is based on the predicted first flight path.

15. One or more non-transitory, computer-readable media having stored thereon instructions that, when executed by one or more processing devices, cause a system to perform operations comprising:
transmitting, while an aircraft is along a first flight path, aircraft state information to a terrain avoidance and warning system (TAWS);
processing TAWS information indicating a ground obstacle along an upcoming portion of the first flight path;
updating a first flight plan to a second flight plan to avoid the ground obstacle based on the TAWS information; and
redirecting an aircraft from the first flight path to a second flight path based on updating the first flight plan to the second flight plan.

16. The one or more non-transitory, computer-readable media as recited in claim 15, the operations further comprising:
prior to the transmitting the aircraft state information, processing a vectorization command to update a third flight plan to the first flight plan, wherein the TAWS information indicates the ground obstacle based on updating the third flight plan to the first flight plan.

17. The one or more non-transitory, computer-readable media as recited in claim 15, the operations further comprising:
transmitting the TAWS information to a flight supervision platform along with a request for the second flight plan; and
processing a response from the flight supervision platform, the response comprising the second flight plan.

18. The one or more non-transitory, computer-readable media as recited in claim 15, the operations further comprising:
determining, locally via a flight plan management system, the second flight plan based on the TAWS information.

19. The one or more non-transitory, computer-readable media as recited in claim 15, the operations further comprising:
processing sensor information comprising position information and altitude information; and
processing first flight plan information with respect to temporal information, wherein the aircraft state information comprises the sensor information and the first flight plan information.

20. The one or more non-transitory, computer-readable media as recited in claim 15, the operations further comprising:
determining a predicted first flight path for a threshold distance, wherein the aircraft state information is based on the predicted first flight path.
